(19) United States
(12) Patent Application Publication
(10) Pub. No.: US 2002/0097128 A1
(43) Pub. Date: Jul. 25, 2002

(54) Electronic component and method of manufacturing

(75) Inventor: Mohamed Imam, Tempe, AZ (US)

Correspondence Address: Robert D. Atkins, Semiconductor Components Industries, LLC, Patent Administration Dept - MD A230, P.O. Box 62890, Phoenix, AZ, 85082-2890, US

(73) Assignee: Semiconductor Components Industries, LLC

(21) Appl. No.: 09/768,381

(22) Filed: Jan. 22, 2001

(51) Int. Cl. H01F 5/00

(52) U.S. Cl. 336/200

(57) ABSTRACT

An electronic component includes a substrate and an inductive element located over the substrate and comprised of at least one winding. The winding of the inductive element includes an electrically conductive layer (120, 520, 620) located over the substrate and another electrically conductive layer (460, 560, 660) located over at least a portion of and electrically coupled to the electrically conductive layer.

### FIELD OF THE INVENTION

This invention relates in general to electronics and, more particularly, to electronic components and methods of manufacturing.

### BACKGROUND OF THE INVENTION

The rise of modern telecommunication systems, such as cordless and cellular telephones, has prompted an increase in the demand for inexpensive Radio Frequency (RF) Integrated Circuits (ICs). These RF ICs require many passive elements such as capacitors, inductors, and/or transformers for inductor capacitor (LC) tank tuning, Alternating Current (AC) coupling, impedance matching, and filtering.

Unlike the integration and miniaturization of other electronic devices such as resistors, the integration and miniaturization of inductors and transformers has proven to be a much more difficult task. Accordingly, inductive elements, such as inductors and transformers, have rarely been used in RF ICs. Instead, the inductance for RF ICs is typically provided either by simulating inductance using active elements within the RF IC or by attaching external, discrete, passive inductive elements to the RF IC. Neither of these RF IC design approaches, however, is compatible with the integration and miniaturization of circuits. Furthermore, both of these RF IC design approaches limit the electrical performance of the final circuit.

Several attempts have been made to integrate and miniaturize inductors and transformers into conventional integrated circuits. Many of these attempts, however, use additional and complicated manufacturing steps and/or exotic materials.

Hence, there is a need for an electronic component and method of manufacturing that has at least one inductive element capable of being miniaturized and integrated into conventional integrated circuits.

### BRIEF DESCRIPTION OF THE DRAWINGS

The invention will be better understood from a reading of the following detailed description, taken in conjunction with the accompanying drawing figures in which:

FIG. 1 illustrates a top view of a portion of an electronic component in accordance with an embodiment of the invention;

FIG. 2 illustrates a top view of the portion of the electronic component after subsequent manufacturing steps in accordance with an embodiment of the invention;

FIG. 3 illustrates a top view of the portion of the electronic component after further manufacturing steps in accordance with an embodiment of the invention;

FIG. 4 illustrates a top view of the portion of the electronic component after still further manufacturing steps in accordance with an embodiment of the invention;

FIG. 5 illustrates a top view of a portion of a different electronic component in accordance with an embodiment of the invention;

FIG. 6 illustrates a top view of a portion of another electronic component in accordance with an embodiment of the invention; and

FIG. 7 illustrates a flow chart of a method of manufacturing an electronic component in accordance with an embodiment of the invention.

For simplicity and clarity of illustration, the drawing figures illustrate the general manner of construction, and descriptions and details of well-known features and techniques are omitted to avoid unnecessarily obscuring the invention. Additionally, elements in the drawing figures are not necessarily drawn to scale, and the same reference numerals in different figures denote the same elements.

Furthermore, the terms first, second, third, and the like in the description and in the claims, if any, are used for distinguishing between similar elements and not necessarily for describing a sequential or chronological order. It is further understood that the terms so used are interchangeable under appropriate circumstances and that the embodiments of the invention described herein are capable of operation in other sequences than described or illustrated herein.

Moreover, the terms left, right, top, bottom, over, under, and the like in the description and in the claims, if any, are used for descriptive purposes and not necessarily for describing relative positions. It is understood that the terms so used are interchangeable under appropriate circumstances and that the embodiments of the invention described herein are capable of operation in other orientations than described or illustrated herein.

### DETAILED DESCRIPTION OF THE DRAWINGS

In the preferred embodiment, an electronic component comprises a semiconductor substrate. The electronic component also comprises an inductive element located over the semiconductor substrate. The inductive element comprises a plurality of coils or windings. The plurality of windings comprise a first metal layer located over at least a portion of the semiconductor substrate. The plurality of windings further comprise a second metal layer located over at least a portion of, and electrically coupled to, the first metal layer.

As an example, the inductive element can be an inductor or a transformer. If the inductive element is an inductor, the inductive element preferably does not have a planar, spiral configuration. Instead, the inductive element preferably has a three-dimensional coil configuration. The inductive element also comprises a core around which the plurality of windings are wound. The core remains electrically floating while the plurality of windings are electrically biased. If the inductive element is a transformer, the core couples the induced magnetic flux from the separate windings.

The inductance of a plurality of windings with n turns per unit length is given by:

L=4π10⁻⁷u·n²·z·A

where u is the magnetic permeability of the core material, z is the length of the core, and A is the cross-sectional area of the core. As a result, by changing the number of turns, the width of the core, and/or the length of the core, the value of the inductance can be varied to meet the requirements of a specific circuit design.

The electronic component can also comprise an optional interconnect system. In some embodiments, the windings of the inductive element and the optional interconnect system can be comprised of the same materials and can be formed simultaneously with each other. The terms “winding” and “windings” preferably do not include the interconnect system.

FIG. 1 illustrates a top view of a portion of an electronic component 100. Component 100 comprises a substrate. The substrate is a support substrate. The substrate can be comprised of a variety of substantially rigid materials, but is preferably comprised of a semiconductor material. As an example, the substrate can be comprised of silicon, silicon germanium, or gallium arsenide.

The substrate can also be comprised of an electrically insulative layer. As an example, the electrically insulative layer can be comprised of silicon dioxide, silicon nitride, silicon oxy-nitride, or Tetra-Ethyl-Ortho-Silicate (TEOS). In this embodiment, the substrate can be a Silicon-On-Insulator (SOI) substrate.

Electronic component 100 also comprises an electrically insulative layer 110 overlying the substrate. In the preferred embodiment, the substrate is directly underneath electrically insulative layer 110. As an example, the electrically insulative layer can be comprised of silicon dioxide, silicon nitride, silicon oxy-nitride, or Tetra-Ethyl-Ortho-Silicate (TEOS).

Electronic component 100 further comprises an inductive element located over layer 110. The inductive element is comprised of at least one winding. FIG. 1 illustrates the beginning formation of a plurality of windings for the inductive element of electronic component 100.

As illustrated in FIG. 1, each of the windings of the inductive element of component 100 comprise different portions of an electrically conductive layer 120. Layer 120 is located over layer 110. Although not illustrated in FIG. 1, other portions of layer 120 can be used to form at least a portion of an optional interconnect system for electronic component 100.

As an example, layer 120 can be comprised of polycrystalline silicon (polysilicon). In this embodiment, the polysilicon is heavily doped. The use of polysilicon for layer 120 makes the manufacturing of the inductive element compatible with conventional bipolar transistor manufacturing processes, Complimentary Metal-Oxide Semiconductor (CMOS) Field Effect Transistor (FET) manufacturing processes, and Bipolar and CMOS (BiCMOS) manufacturing processes.

In a different embodiment, layer 120 can be comprised of a metal. As an example, the metal can be comprised of aluminum, copper, tungsten, gold, or titanium. In the preferred embodiment, layer 120 is comprised of the same material as a subsequently deposited electrically conductive layer used to form other portions of the windings for the inductive element. This homogeneity of the windings provides superior electrical performance for the inductive element and for electronic component 100.

Electronic component 100 can comprise an optional electronic device 115 identified by dashed lines in FIG. 1. Device 115 is supported by the substrate. The inductive element is located over at least a portion of device 115. Device 115 can be an active or a passive device. As an example of an active device, device 115 can be a transistor. As an example of a passive device, device 115 can be a resistor. In the preferred embodiment, device 115 is not sensitive to RF coupling from the inductive element. Regardless of whether device 115 is an active or passive device, device 115 can be located at least partially within the substrate, or device 115 can be located over the substrate.

If optional electronic device 115 is not present in electronic component 100, then component 100 can be a discrete component. If device 115 is present in component 100, then component 100 can be an integrated circuit. In a different embodiment of an integrated circuit, the inductive element in component 100 is not located over another device in component 100. In this embodiment, electronic component 100 will likely be a larger component and may have a higher cost. Optional device 115 is not illustrated in the subsequent figures to simplify and to clarify the explanation of the subsequent manufacturing process for electronic component 100.

FIG. 2 illustrates a top view of a portion of electronic component 100 after subsequent manufacturing steps. An electrically insulative layer 230 is formed over electrically conductive layer 120, which is illustrated by dashed lines in FIG. 2 and in subsequent drawing figures. The electrically insulative layer has holes 235 exposing portions of layer 120. As an example, electrically insulative layer 230 can be comprised of silicon dioxide, silicon nitride, silicon oxy-nitride, Spin-On-Glass (SOG), TEOS, or photoresist.

As illustrated in FIG. 2, electronic component 100 also comprises an electrically conductive layer 240. Layer 240 can serve as a core for the inductive element, regardless of whether the inductive element is an inductor or a transformer. Although not illustrated in FIG. 2, other portions of layer 240 can be used as at least a portion of an optional interconnect system for electronic component 100.

The portion of layer 240 used for the core is preferably devoid of being electrically shorted to the portions of layer 120 used for the windings. Electrically conductive layer 240 is electrically insulated from electrically conductive layer 120 by electrically insulative layer 230. Layer 240 is located over at least a portion of electrically insulative layer 230 and also over at least a portion of electrically conductive layer 120.

In one embodiment, electrically conductive layer 240 can be comprised of polysilicon, similar to that described earlier for layer 120. In another embodiment, layer 240 can be comprised of a metal, similar to that described earlier for layer 120. In yet another embodiment, layer 240 can be comprised of an electrically conductive material that is also a magnetic material.

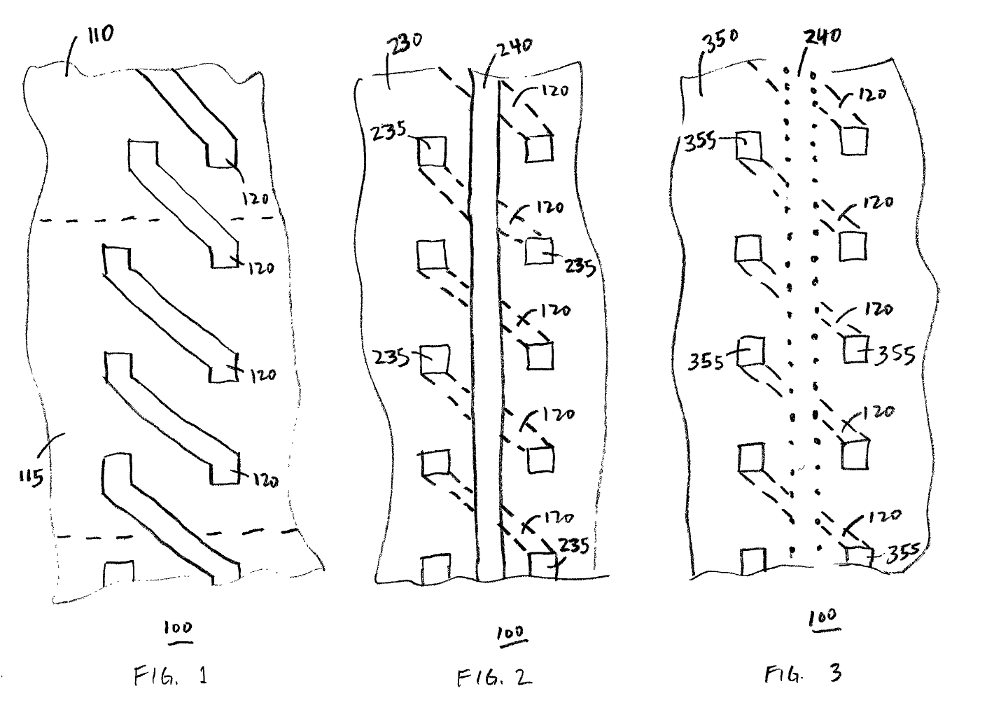

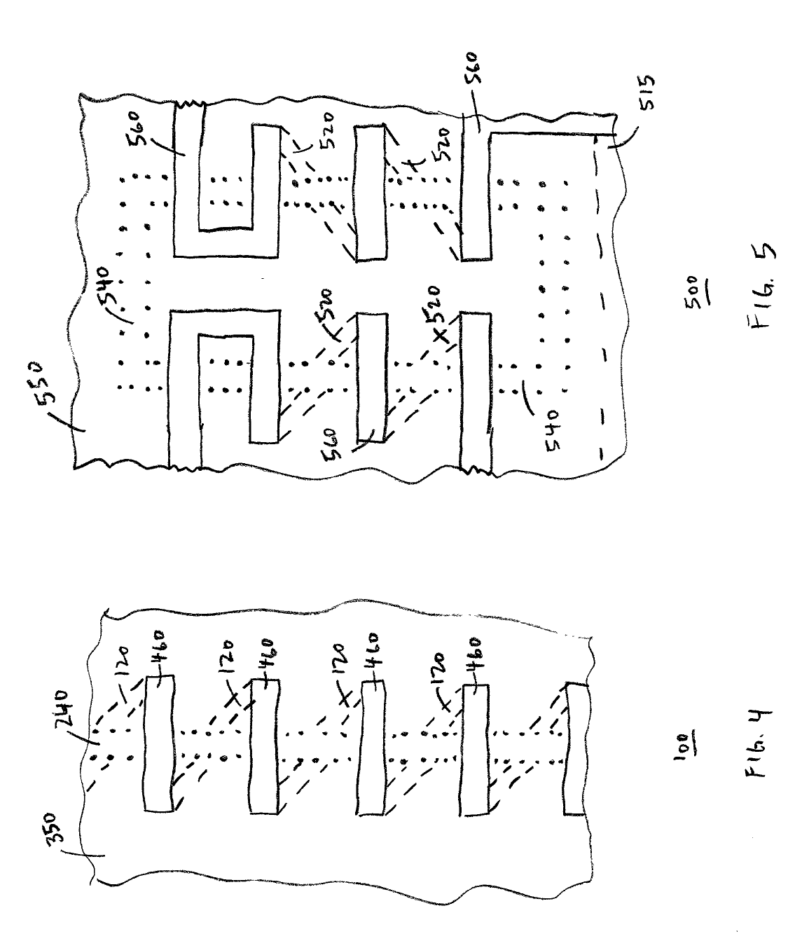

FIG. 3 illustrates a top view of the portion of electronic component 100 after further manufacturing steps. An electrically insulative layer 350 is formed over electrically conductive layer 240, which is illustrated by dotted lines in FIG. 3 and in subsequent drawing figures. In the preferred embodiment, layer 350 is comprised of the same material as electrically insulative layer 230 in FIG. 2. Layer 350 comprises holes 355 that expose holes 235 (FIG. 2) of layer 230 (FIG. 2) and that also expose portions of layer 120. Layer 350 is located over at least a portion of layers 110, 120, 230, and 240.

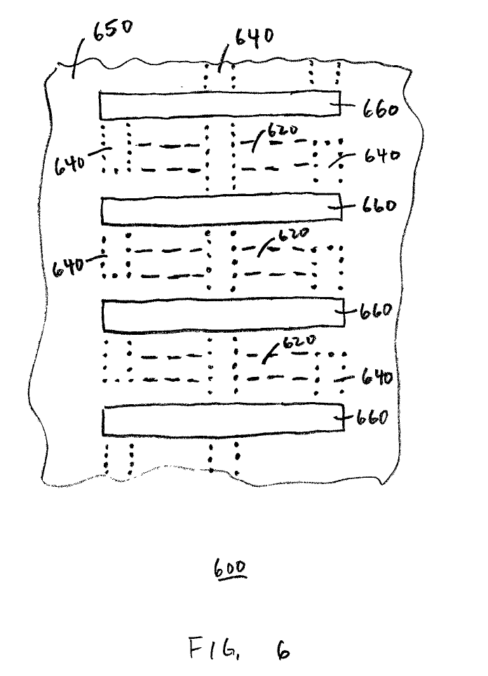

FIG. 4 illustrates a top view of the portion of electronic component 100 after still further manufacturing steps. As illustrated in FIG. 4, the inductive element further comprises an electrically conductive layer 460. Layer 460 is located over at least a portion of electrically conductive layer 240 and electrically insulative layers 230 and 350. Layer 460 is also located over at least a portion of electrically conductive layer 120. Layer 460 is also electrically coupled to layer 120 through holes 355 (FIG. 3) in electrically insulative layer 350 (FIG. 3) and holes 235 (FIG. 2) in layer 230 (FIG. 2). Electrically conductive layer 460 is electrically insulated from electrically conductive layer 240 by electrically insulative layer 350. Each of the windings in the inductive element comprises a different portion of electrically conductive layer 460.

In one embodiment, layer 460 can be comprised of polysilicon, as described earlier with respect to layer 120. In a different embodiment, layer 460 can be comprised of a metal, also described earlier with respect to layer 120. In the preferred embodiment, layer 460 is comprised of the same material as layer 120 for reasons related to homogeneity as explained earlier with respect to layer 120.

Although not illustrated in FIG. 4, other portions of layer 460 can be used to form at least a portion of an optional interconnect system for electronic component 100. Furthermore, the manufacturing process for component 100 can comprise additional steps, including steps to form a passivation layer over the inductive element, to form bond pads for electronic component 100, and to assemble component 100 in a package.

FIG. 5 illustrates a top view of a portion of an electronic component 500. Component 500 is a different embodiment of component 100 in FIG. 4. Component 500 comprises a substrate similar to the substrate of component 100 in FIG. 1. Component 500 further comprises an electrically conductive layer 520, which is similar to layer 120 in FIG. 4. Component 500 additionally comprises an electrically conductive layer 540, which is similar to electrically conductive layer 240 in FIG. 4. Component 500 further comprises an electrically conductive layer 560, which is similar to electrically conductive layer 460 in FIG. 4. Layer 540 forms a core for the transformer, and layers 520 and 560 form the windings for the transformer.

Electronic component 500 further comprises an electrically insulative layer separating the substrate and layer 520 from each other. This electrically insulative layer can be similar to layer 110 in FIG. 1. Component 500 still further comprises another electrically insulative layer separating layers 520 and 540 from each other. This electrically insulative layer is similar to layer 230 in FIG. 2. Component 500 yet further comprises an electrically insulative layer 550, which separates layers 540 and 560 from each other. Layer 550 is similar to layer 350 in FIG. 4.

As illustrated in FIG. 5, the inductive element in component 500 is a transformer. The windings at the left side of the transformer are preferably electrically biased separately from the windings at the right side of the transformer. The spacing between, the size of, the configuration of, and the number of windings at either side of the transformer can be the same or different from each other. The core couples the induced magnetic flux from the windings at the left side of the transformer to the induced magnetic flux from the windings at the right side of the transformer, and vice versa. The dielectric isolation between the windings at the right and left sides of the transformer provides high voltage isolation between the input and output signals and makes the transformer useful in providing high voltage isolation between separate portions of electronic component 500 that are sensitive to high voltage transients.

As illustrated in FIG. 5, electronic component 500 can further comprise an optional electronic device 515. Device 515 in FIG. 5 can be similar to device 115 in FIG. 1. Device 515, however, is illustrated to be absent underneath the inductive element.

Also illustrated in FIG. 5, a portion of electrically conductive layer 560 is used in an interconnect system to electrically couple the inductive element to device 515. When component 500 comprises an interconnect system having three layers, portions of electrically conductive layers 520, 540, and 560 are used to form the inductive element, while other portions of layers 520, 540, and 560 can be used to form the interconnect system. In this embodiment, the inductive element and the interconnect system are formed simultaneously with each other.

In an embodiment where the interconnect system has more than three layers, layers 520, 540, and 560 are preferably the top three electrically conductive layers or the last three electrically conductive layers to be formed in the interconnect system. In this embodiment, the inductive element is located as far away as possible from the substrate to avoid, or at least reduce, resistive and/or capacitive coupling losses. In this embodiment, the parasitic resistances in the inductive element are reduced to improve the electrical performance of the inductive element.

Furthermore, when the interconnect system has more than three layers, layers 520, 540 and 560 are preferably adjacent layers within the interconnect system to provide better inductive coupling within the inductive element. The better inductive coupling is due to the reduced dielectric loss within the electrically insulative material and provided by the thinner electrically insulative material between layers 520, 540, and 560. With better inductive coupling, the inductive element can have fewer windings, which can reduce the size of the inductive element. The smaller size of the inductive element can reduce the size and cost of electronic component 500.

FIG. 6 illustrates a top view of a portion of an electronic component 600. Component 600 in FIG. 6 is a different embodiment of component 400 in FIG. 4. Component 600 comprises a substrate that can be similar to the substrate of component 100 in FIG. 1. Component 600 also comprises an electrically conductive layer 620, which can be similar to layer 120 in FIG. 4. Component 600 can further comprise an electrically conductive layer 640, which can be similar to electrically conductive layer 240 in FIG. 4. Electronic component 600 still further comprises an electrically conductive layer 660, which can be similar to layer 460 in FIG. 4.

Electronic component 600 further comprises an electrically insulative layer separating the substrate and layer 620 from each other. This electrically insulative layer can be similar to layer 110 in FIG. 1. Component 600 still further comprises another electrically insulative layer separating layers 620 and 640 from each other. This electrically insulative layer is similar to layer 230 in FIG. 2. Component 600 yet further comprises an electrically insulative layer 650, which separates layers 640 and 660 from each other. Layer 650 is similar to layer 350 in FIG. 4.

Electronic component 600 in FIG. 6 is similar to electronic component 100 in FIG. 4, except that the windings illustrated in FIG. 6 are each comprised of three separate electrically conductive layers, while the windings in FIG. 4 are each comprised of two electrically conductive layers. As illustrated in FIG. 6, electrically conductive layer 640 can be used to form both the core for the inductive element, as well as the windings for the inductive element. The core of the inductive element in FIG. 6, however, is still not electrically shorted to the windings in the inductive element.

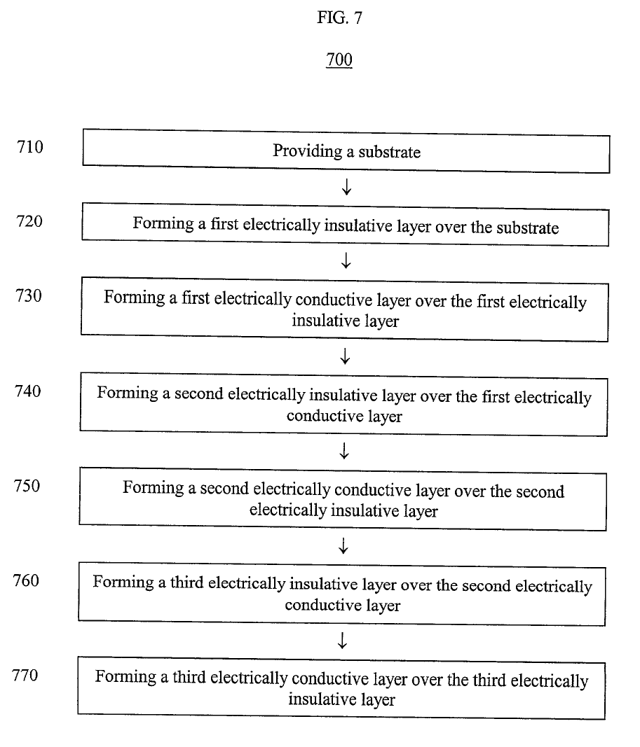

FIG. 7 illustrates a flow chart 700 of a method of manufacturing an electronic component. As an example, the electronic component in this method can be similar to any of components 100, 500, and 600 in FIGS. 4, 5, and 6, respectively. At a step 710 in flowchart 700, a substrate is provided. As an example, the substrate of step 710 can be similar to the substrate located under layer 110, as described earlier with respect to FIG. 1.

At a step 720 of flow chart 700 in FIG. 7, an electrically insulative layer is formed over the substrate of step 710. As an example, the electrically conductive layer of step 720 can be similar to electrically insulative layer 110 in FIG. 1.

Next, at a step 730 in flow chart 700 of FIG. 7, an electrically conductive layer is formed over the electrically insulative layer of step 720. As an example, the electrically conductive layer of step 730 can be similar to electrically conductive layer in 120 in FIG. 4, electrically conductive layer 520 in FIG. 5, and/or electrically conductive layer 620 in FIG. 6.

At a step 740 in flow chart 700 of FIG. 7, an electrically insulative layer is formed over the electrically conductive layer of step 730. As an example, the electrically insulative layer of step 740 can be similar to electrically insulative layer 230 in FIG. 2.

Then, at a step 750 in flow chart 700 of FIG. 7, an electrically conductive layer is formed over the electrically insulative layer of step 740. As an example, the electrically conductive layer of step 750 can be similar to electrically conductive layer 240 of FIG. 4, electrically conductive layer 540 of FIG. 5, and/or electrically conductive layer 640 of FIG. 6.

In one embodiment of step 750, the electrically conductive layer of step 750 is entirely electrically isolated from the electrically conductive layer of step 730. In another embodiment of step 750, a portion of the electrically conductive layer of step 750 can be formed to be electrically coupled to the electrically conductive layer of step 730, and another portion of the electrically conductive layer of step 750 can be formed to be electrically isolated from the electrically conductive layer of step 730.

At a step 760 of flow chart 700 in FIG. 7, an electrically insulative layer is formed over the electrically conductive layer of step 750. As an example, the electrically insulative layer of step 760 can be similar to electrically insulative layer 350 of FIG. 4, electrically insulative layer 550 of FIG. 5, and/or electrically insulative layer 650 of FIG. 6.

Next, at a step 770 of flow chart 700 in FIG. 7, an electrically conductive layer is formed over the electrically insulative layer of step 760. The electrically conductive layer is formed over at least a portion of, and is electrically coupled to, the electrically conductive layer of step 730 and, optionally, the electrically conductive layer of step 750. As an example, the electrically conductive layer of step 770 can be similar to electrically conductive layer 460 of FIG. 4, electrically conductive layer 560 of FIG. 5, and/or electrically conductive layer 660 of FIG. 6.

In summary, an improved electronic component and method of manufacturing is provided to overcome the disadvantages of the prior art. The electronic component is miniaturized and can be integrated into an integrated circuit with other conventional integrated circuit devices. The manufacturing process for the inductive element does not require any new materials or new or additional process steps. Instead, the etch masks used to define the pattern of the electrically conductive layers and the etch masks used to define the pattern of the electrically insulative layers can be changed.

Although the invention has been described with reference to specific embodiments, it will be understood by those skilled in the art that various changes may be made without departing from the spirit or scope of the invention. For instance, the numerous details set forth herein such as, for example, the specific shape and/or configuration of the windings in the inductive element, are provided to facilitate the understanding of the invention and are not provided to limit the scope of the invention. As an example, the transformer can have a variety of other configurations including, but not limited to, (1) a single plurality of windings around a straight core and an electrical tap in the middle of the core, (2) a first plurality of windings around a first portion of a straight core and a second plurality of windings around a second portion of the straight core, and (3) two inter-digitated windings around a straight or bent core. Furthermore, the different concepts, shapes, and/or configurations of the inductive elements in component 100 of FIG. 4, in component 500 of FIG. 5, in component 600 in FIG. 6, and in the examples described earlier in this paragraph can be combined or interchanged with each other. Accordingly, the disclosure of embodiments of the invention is intended to be illustrative of the scope of the invention and is not intended to be limiting. It is intended that the scope of the invention shall be limited only to the extent required by the appended claims.

What is claimed is:

1. An electronic component, comprising:
a substrate;
an inductive element located over the substrate and comprised of at least one winding, the at least one winding comprising:
at least a portion of a first electrically conductive layer located over the substrate; and
at least a portion of a second electrically conductive layer located over and electrically coupled to the at least a portion of the first electrically conductive layer.

2. The electronic component of claim 1, wherein:
the inductive element further comprises a core;
the at least one winding is wound around the core; and
the core comprises:
at least a portion of a third electrically conductive layer located between the at least a portion of the first electrically conductive layer and the at least a portion of the second electrically conductive layer.

3. The electronic component of claim 2, wherein:
the at least one winding is electrically biased while the core is electrically floating.

4. The electronic component of claim 1, wherein:
the at least one winding further comprises:
at least a portion of a third electrically conductive layer located over and electrically coupled to the at least a portion of the second electrically conductive layer.

5. The electronic component of claim 4, wherein:
the inductive element further comprises a core;
the at least one winding is wound around the core;
the core comprises:
a different portion of the second electrically conductive layer; and
the different portion of the second electrically conductive layer is electrically isolated from the at least a portion of the second electrically conductive layer.

6. The electronic component of claim 1, wherein:
the inductive element further comprises:
a plurality of windings comprising the at least one winding.

7. The electronic component of claim 6, wherein:
each of the plurality of windings comprises:
the first electrically conductive layer; and
the second electrically conductive layer.

8. The electronic component of claim 7, wherein:
each of the plurality of windings further comprises:
at least a portion of a third electrically conductive layer located over and electrically coupled to the at least a portion of the second electrically conductive layer.

9. The electronic component of claim 8, wherein:
the inductive element further comprises a core;
each of the plurality of windings is wound around the core;
the core comprises:
a different portion of the second electrically conductive layer; and
a different portion of the second electrically conductive layer is electrically isolated from the at least a portion of the second electrically conductive layer.

10. The electronic component of claim 7, wherein:
the inductive element further comprises a core;
the plurality of windings are wound around the core; and
the core comprises:
at least a portion of a third electrically conductive layer located between the first and second electrically conductive layers.

11. The electronic component of claim 1, further comprising:
an electronic device supported by the substrate; and
an interconnect system located over the substrate and electrically coupled to the electronic device and the inductive element, wherein:
the interconnect system is comprised of the second electrically conductive layer.

12. The electronic component of claim 11, wherein:
the interconnect system is comprised of the first electrically conductive layer.

13. The electronic component of claim 11, wherein:
the inductive element is located over the electronic device.

14. The electronic component of claim 11, wherein:
the inductive element is absent over the electronic device.

15. The electronic component of claim 1, wherein:
the first electrically conductive layer is comprised of polysilicon.

16. The electronic component of claim 1, wherein:
the first electrically conductive layer is comprised of a metal.

17. The electronic component of claim 1, wherein:
the second electrically conductive layer is comprised of a metal.

18. The electronic component of claim 1, wherein:
the inductive element is an inductor.

19. The electronic component of claim 1, wherein:
the inductive element is a transformer.

20. An electronic component, comprising:
a semiconductor substrate;
an inductive element located over the semiconductor substrate and comprised of a plurality of windings, the plurality of windings comprising:
at least a portion of a first metal layer located over the semiconductor substrate; and
at least a portion of a second metal layer located over and electrically coupled to the at least a portion of the first metal layer.

21. The electronic component of claim 20, wherein:
the inductive element further comprises a core;
the core comprises:
the at least a portion of an electrically conductive layer located between the first and second metal layers;
the plurality of windings are wound around the core; and
the core is electrically floating while the plurality of windings are electrically biased.

22. The electronic component of claim 20, wherein:
the inductive element further comprises a core;
the core comprises:
a different portion of the second metal layer;
the plurality of windings are wound around the core;
the core is electrically floating while the plurality of windings are electrically biased; and
the electronic component further comprises:
at least a portion of a third metal layer located over and electrically coupled to the at least a portion of the second metal layer.

23. The electronic component of claim 20, further comprising:
a transistor located at least partially in the semiconductor substrate; and
an interconnect system located over the semiconductor substrate and electrically coupled to the transistor and the inductive element, wherein:
the interconnect system is comprised of a different portion of the first metal layer and a different portion of the second metal layer.

24. A method of manufacturing an electronic component, comprising:
providing a substrate;
forming a first electrically conductive layer over the substrate; and
forming a second electrically conductive layer over and electrically coupled to the first electrically conductive layer, wherein:
at least a portion of each of the first and second electrically conductive layers form at least a portion of at least one winding for an inductive element.

25. The method of claim 24, further comprising:
forming a third electrically conductive layer over the first electrically conductive layer before forming the second electrically conductive layer, wherein:
at least a portion of the third electrically conductive layer forms at least a portion of a core for the inductive element; and
forming the second electrically conductive layer further comprises:
forming the second electrically conductive layer over the third electrically conductive layer.

26. The method of claim 24, further comprising:
forming a third electrically conductive layer over the second electrically conductive layer, wherein:
at least a portion of the third electrically conductive layer forms a portion of the at least one winding for the inductive element.

27. The method of claim 26, wherein:
a different portion of the second electrically conductive layer forms at least a portion of a core for the inductive element.
